(19) United States
(12) Patent Application Publication
(10) Pub. No.: US 2015/0038148 A1
(43) Pub. Date: Feb. 5, 2015

(54) METHOD AND APPARATUS FOR HANDOVER BASED ON COOPERATION BETWEEN BASE STATIONS

(71) Applicant: Electronics and Telecommunications Research Institute, Daejeon (KR)

(72) Inventors: Hyun Seo PARK, Daejeon (KR); Ae-Soon PARK, Daejeon (KR)

(73) Assignee: Electronics and Telecommunications Research Institute, Daejeon (KR)

(21) Appl. No.: 14/447,000

(22) Filed: Jul. 30, 2014

(30) Foreign Application Priority Data
Aug. 1, 2013 (KR) 10-2013-0091316
Jul. 22, 2014 (KR) 10-2014-0092630

(51) Int. Cl. H04W 36/00

(52) U.S. Cl. CPC H04W 36/0072; H04W 36/0055; H04W 88/08
USPC 455/437; 455/561

(57) ABSTRACT

A method and apparatus for handover based on cooperation between base stations are provided. When a message indicating handover completion is received from a terminal that has determined whether to perform handover and that has performed handover to a target base station, the target base station transmits a message requesting information on the terminal to a serving base station of the terminal. Then, the target base station receives information on the terminal from the serving base station and transmits data to the terminal.

### CROSS-REFERENCE TO RELATED APPLICATION

This application claims priority to and the benefit of Korean Patent Application No. 10-2013-0091316 and No. 10-2014-0092630 filed in the Korean Intellectual Property Office on Aug. 1, 2013 and Jul. 22, 2014, the entire contents of which are incorporated herein by reference.

### BACKGROUND OF THE INVENTION

(a) Field of the Invention

The present invention relates to a handover, and more particularly, to a method and apparatus for executing a handover based on cooperation between base stations.

(b) Description of the Related Art

Generally, in a mobile communication system, a handover is executed when a moving terminal attempts to access another base station.

The terminal measures the signal strength of neighboring base stations and reports it to a source base station, and the source base station determines a target base station based on the signal strength of neighboring base stations and instructs the terminal to perform handover.

At this time, the source base station having transmitted a handover command message transfers data sequence number information and data of the terminal to the target base station so that seamless handover may be performed.

The terminal having received the handover command message immediately performs the handover to attempt a connection to the target base station.

However, it is difficult for a terminal to send a signal strength report in real time to a base station because the radio link is not in a good state within a handover region such that it is difficult for the base station to send a handover command in real time to the terminal.

As a result, the interruption time of data transmission to the terminal during handover increases, and causes an inevitable decline in communication quality during handover.

### SUMMARY OF THE INVENTION

The present invention has been made in an effort to provide a method and apparatus for executing a handover based on cooperation between base stations.

Further, the present invention has been made in an effort to provide a method and apparatus for performing seamless handover.

According to an aspect of the present invention, a method for handover is provided. The method includes: receiving, by a target terminal, a message indicating handover completion from a terminal, wherein the terminal determines whether to perform handover and performs handover to the target base station; transmitting, by the target base station, a message requesting information on the terminal to a serving base station of the terminal after receiving the message indicating handover completion; receiving, by the target base station, the information on the terminal from the serving base station; and transmitting, by the target base station, data to the terminal.

The transmitting of a message requesting information may determine that an abnormal case in which the terminal has performed handover without notifying of performing handover occurs when there is no information on the terminal in the target base station, and transmit the message requesting information to the serving base station.

The abnormal case may represent that the serving base station cannot receive a handover indication message even though the terminal having determined handover timing according to a handover command from the serving base station transmits the handover indication message notifying of handover execution.

The transmitting of message requesting information may transmit a message requesting data sequence number information and data of the terminal to the serving base station.

The method may further include, after the transmitting of a message requesting information, transferring, by the serving base station, a sequence number of a PDCP (packet data convergence protocol) SDU (service data unit) being retransmitted, packets in a buffer, and packets received from a gateway.

Also, the method may further include: before the receiving of a message indicating handover completion, receiving, by the target base station, a handover request message including information on context of the terminal from the serving base station; and determining, by the target base station, whether to accept a handover request based on the information and transmitting a handover request response message to the serving base station when accepting the handover request.

In this case, the method may further include transferring information on the terminal to the target base station according to a message requesting the transferring of the information, and then requesting neighboring base stations prepared for handover except for the target base station to release radio resources for the terminal.

Meanwhile, the message indicating handover completion may be received after the terminal determines whether to perform handover based on a handover execution event and then performs handover to the target base station.

The handover execution event may include at least one among a case in which signal strength of the neighboring base station is greater than signal strength of the serving base station by a first offset value or more, a case in which the signal strength of the neighboring base station is maintained greater than the signal strength of the serving base station by a second offset value or more during a given TTE (time to execute), a case in which the signal strength of the neighboring base station is greater than the signal strength of the serving base station and the signal strength of the serving base station is less than a predetermined first threshold, and a case in which the signal strength of the neighboring base station is greater than the signal strength of the serving base station and the signal strength of the neighboring base station is greater than a predetermined second threshold.

According to an aspect of the present invention, an apparatus for handover is provided. The apparatus includes a handover completion receiver for receiving a message indicating handover completion from a terminal having determined whether to perform handover or not and having performed handover to a target base station; a data forwarding request processor for transmitting a message requesting information on the terminal to a serving base station when the message indicating handover completion is received; and a data forwarding processor for receiving the information on the terminal from the serving base station and transmitting data to the terminal.

The data forwarding request processor may determine that an abnormal case in which the terminal having performed handover without notifying of performing handover occurs when there is no information on the terminal in the target base station, and transmit the message requesting information to the serving base station.

The message requesting information may be a message requesting data sequence number information and data of the terminal.

Meanwhile, the apparatus may further include: a handover request receiver for receiving a handover request message that includes information including context of the terminal from the serving base station; and a handover acceptance determining processor for determining whether to accept the handover request based on the information and that transmits a handover request response message to the serving base station when accepting the handover request.

The message indicating handover completion may be received after the terminal determines whether to perform handover based on a handover execution event and then performs handover to the target base station.

### BRIEF DESCRIPTION OF THE DRAWINGS

FIG. 1 is a view showing a network environment where handover is performed according to an exemplary embodiment of the present invention.

FIG. 2 is a flowchart of a handover method according to the exemplary embodiment of the present invention.

FIG. 3 is an illustration of event occurrence based on signal strength in the handover method according to the exemplary embodiment of the present invention.

FIG. 4 is a view showing the structure of a handover apparatus according to an exemplary embodiment of the present invention.

FIG. 5 is a view showing the structure of a handover apparatus according to another exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout this specification and the claims which follow, unless explicitly described to the contrary, the word “comprise” and variations such as “comprises” or “comprising” will be understood to imply the inclusion of stated elements but not the exclusion of any other elements.

In this specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the MT, the MS, the AMS, the HR-MS, the SS, the PSS, the AT, the UE, etc.

A base station (BS) may designate an advanced base station (ABS), a high reliability bas station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (HR-RS) serving as a base station, a high reliability relay station (HR-RS) serving as a base station, a small base station (femto BS, a home node B (HNB), a home eNodeB (HeNB), a pico BS, a metro BS, a micro BS, etc.), etc., and may include all or some functions of the ABS, nodeB, eNodeB, AP, RAS, BTS, MMR-BS, RS, RN, ARS, HR-RS, small base station, etc.

Hereinafter, a handover method and apparatus according to an exemplary embodiment of the present invention will be described.

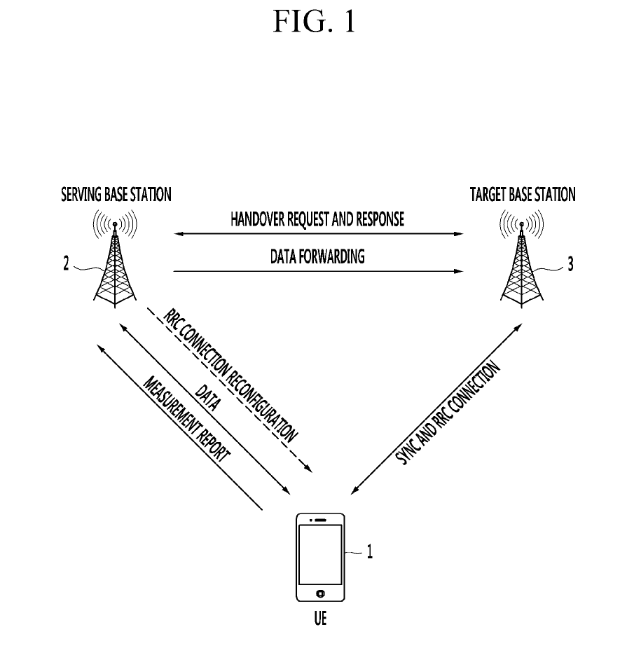

FIG. 1 is a view showing a network environment where handover is performed according to an exemplary embodiment of the present invention.

As shown in the attached FIG. 1, in a network environment where a plurality of small cells coexist, a terminal 1 makes a connection to a given cell via a base station which is in charge of the cells. The terminal 1 may perform a handover from a serving base station 2 (it may also be referred to as a source base station) of a current connected cell to a target base station 3 while it is moving.

In such a radio channel environment, conventionally, when the terminal measures the strength of signals received from a serving base station and neighboring base stations and transmits channel state information of a serving cell and neighboring cells to the serving base station through a measurement report message, the serving base station determines if the terminal is required to handover and transmits a handover command message to the terminal. Afterwards, the terminal immediately performs handover to cut off its wireless connection with the serving base station and attempts a connection to a target base station.

As the terminal performs random access to the target base station, the target base station sends a random access response to the terminal, and then the target base station determines that the handover is successful and may start to transmit downlink data.

The terminal is not able to receive data during a handover interruption time, which starts from the time at which the terminal cuts off the wireless connection with the serving base station, and attempts a connection to the target base station and ends at the initial reception of downlink data following the success of a RACH (random access channel) procedure for the target base station. The handover interruption time for which the terminal cannot receive data during handover is defined as around 10.5 ms according to the standards.

In reality, however, downlink data transmission stops at the time when the serving base station transmits a handover command message to the terminal. Therefore, the handover interruption time is much longer than that defined in the standards. Real-time transmission of the signal strength report to the base station and transmission of the handover command from the base station to the terminal may not be possible due to a bad radio link state in a handover region. Hence, it is highly likely that the terminal will not perform handover as a real-time response to the radio link state or the handover itself will fail. Consequently, data interruption time during handover will be further lengthened, or communication quality will inevitably decline during handover due to data interruption time in a recovery procedure following a handover failure.

Therefore, according to the exemplary embodiment of the present invention, the terminal makes a final determination about the handover timing so as to perform handover in real time depending on the radio link state and increases the success rate of handover.

When the terminal determines the handover timing, the terminal reports the results of the signal strength measurement of the neighboring base stations, receives a handover command message for commanding handover from a serving base station, then determines the handover timing (e.g., it may be determined as the handover timing when the signal strength of the target base station is greater than the signal strength of the serving base station for a predetermined time), and notifies of the handover timing to the serving base station through a handover indication message.

Since a terminal determines the timing of handover, handover is performed based on base station signal strength measurement results acquired in real time from the terminal. As a result, the success rate of handover is improved, and data interruption time during handover is significantly shortened.

Meanwhile, when the radio link between a terminal and a serving base station is not in a good state, a transmission error may occur, thereby it causes a case in which the serving base station cannot receive the handover indication message transmitted from the terminal.

According to an exemplary embodiment of the present invention, when the handover to a target base station has been completed by a terminal, the target base station notifies of the handover completion of the terminal to the serving base station and requests the serving base station to send the data sequence number information and data of the terminal. As a result, seamless handover may be performed.

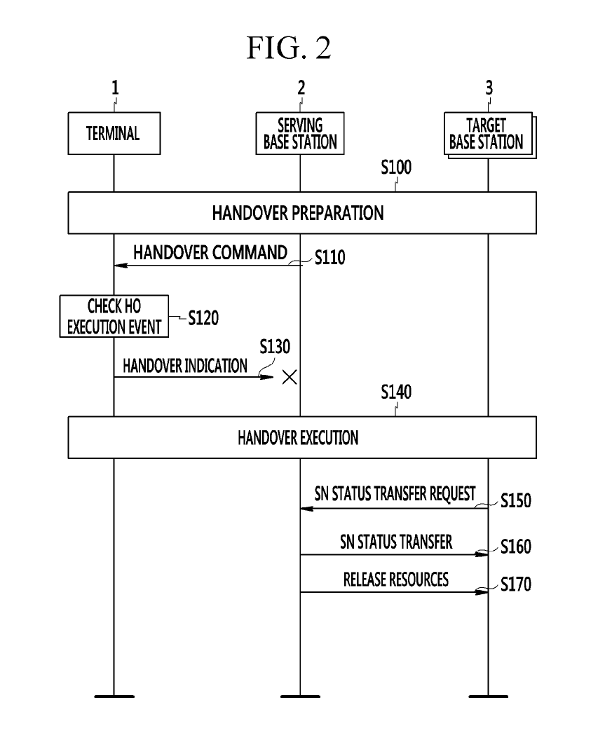

FIG. 2 is a flowchart of a handover method according to the exemplary embodiment of the present invention.

The terminal 1 measures signal strength of the serving base station 2 and neighboring base stations, and reports the wireless signal measurement result through a measurement report message.

The terminal 1 may transmit the measurement report message, for example, when the difference between the signal strength of the serving base station and the signal strength of the neighboring base station is greater than an HOM (handover margin) (e.g., 2 dB).

The serving base station 2 selects at least one to which the terminal 1 can perform handover from among neighboring base stations, based on the wireless signal measurement result of the neighboring base stations provided from the terminal 1.

At this time, the serving base station 2 may transmit a handover request message to the selected neighboring bases stations.

The handover request message may include information for including the context of the terminal and others.

The neighboring base station having received the handover request message, that is, a potential target base station, determines whether to accept handover based on the context information of the terminal, and if it accepts handover, transmits a handover request ACK message containing information required to connect to the target base station to the serving base station 2

As the potential target base station accepts handover, the serving base station 2 transmits a handover command message, i.e., an RRC connection reconfiguration message, for configuring a neighboring base station as a target base station to the terminal 1.

At this time, information indicating whether the UE has to perform a RACH procedure after handover may be contained and transmitted in the RRC connection configuration message.

After such a handover preparation process has been performed (S100), the terminal 1 continues to measure the signal strength of the serving base station 2 and the neighboring base stations when receiving a handover command message for commanding handover, and determines the handover timing based on the results of the measurement (S120).

When the results of the measurement are satisfied with a predetermined handover execution event, the terminal 1 determines the best handover timing and the best target base station for handover.

The handover execution event according to an exemplary embodiment of the present invention represents the state in which performing handover to a target station is better than maintaining a connection to a serving base station.

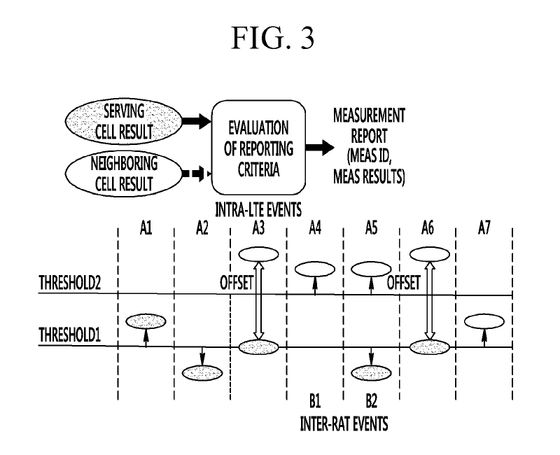

FIG. 3 is an illustration of event occurrence based on signal strength in the handover method according to the exemplary embodiment of the present invention.

The terminal 1 may determine the timing of handover as it is determined that the handover execution event occurs in the following cases.

The case (A3 in FIG. 3) in which the signal strength of the neighboring base station is greater than the signal strength of the serving base station by a first offset value (ex. 3 dB) or more. The case in which the signal strength of the neighboring base station is maintained greater than the signal strength of the serving base station by a second offset value or more during a given time (e.g., TTE (time to execute)). The case (A2 in FIG. 3) in which the signal strength of the neighboring base station is greater than the signal strength of the serving base station and the signal strength of the serving base station is less than a predetermined first threshold (Threshold1). The case in which the signal strength of the neighboring base station is greater than the signal strength of the serving base station and the signal strength of the neighboring base station is greater than a predetermined second threshold (Threshold2).

The handover execution event according to an exemplary embodiment of the present invention is not restricted thereto.

Meanwhile, the terminal 1 may determine a target base station based on the measured signal strength of the neighboring base station.

For example, from among the neighboring base stations of which the signal strength is greater than that of the serving base station, a neighboring base station of which the signal strength is greater than that of the serving base station by a first offset value or more is selected as a target base station.

The terminal 1 can receive at least one handover command message, wherein each of the handover command messages has a different target base station.

In this case, the terminal 1 determines a best target base station for handover while determining the best timing of handover.

In FIG. 2, the terminal 1 generates a handover indication message and transmits it to the serving base station 2 when it is determined that handover has to be performed (S130).

The handover indication message may include information about the target base station determined by the terminal 1.

The handover indication message may be transmitted to the serving base station by using a variety of handover notification methods (e.g., a handover notification method using a MAC control element, a handover notification method using an RRC message, a handover notification method using a physical channel, and others).

Here, when the handover execution is notified to the serving base station 2, the terminal 1 may repeatedly transmit the handover indication message for the reliability of the transmitted message.

The serving base station 2 may transmit a response message about whether the handover indication message is received or not to the terminal 1.

For example, an ACK (ACKnowledgment) response message indicating that the handover indication message is properly received is transmitted to the terminal 1, or a NACK (Negative ACKnowledgment) response message indicating that the handover indication message is not properly received is transmitted to the terminal 1.

At this time, the handover indication message form the terminal 1 may not be properly received by the serving base station 2 according to the state of the wireless link (a case “X” in “FIG. 2).

After transmitting the handover indication message, the terminal 1 may determine that the handover indication message is not properly transmitted when an ACK error (e.g., PHICH NACK to ACK Error) occurs, or when an ACK indicating the successful reception is not received from the serving base station even though the handover indication message is repeatedly transmitted a predetermined maximum transmission number of times (e.g. the maximum HARQ (hybrid automatic repeat request)).

The terminal 1 performs handover to a target base station after transmitting the handover indication message.

At this time, the terminal 1 may perform handover to the target base station when it is determined that the handover indication message is not properly transmitted (transmission failure), when a response message (ACK) indicating that the indication message is properly received is received from the serving base station, or directly after transmitting the handover indication message regardless of the transmission failure occurrence or whether the response message is received.

The terminal 1 performs handover to the target base station and then transmits a handover completion message to the target base station 3 (S140).

The target base station 3 having received the handover completion message from the terminal 1 determines whether to receive the data sequence number information and data of the terminal 3.

When the data sequence number information and data of the terminal 1 are not received from the serving base station 2, the target base station determines that the terminal 3 has performed handover without notifying of the handover execution to the serving base station, that is, an abnormal case in which the handover indication message is not properly received by the serving base station occurs.

In this case, the target base station 3 transmits an information transfer request message (e.g., SN (sequence number) status transfer request message) for requesting the data sequence number information and data of the terminal 1 to the serving base station 2 (S150).

The serving base station 2 having received the information transfer request message sends the data sequence number information and data of the terminal 1 to the target base station 3 (S160).

At this time, the serving base station 2 may forward, for example, the sequence number of a PDCP (packet data convergence protocol) SDU (service data unit) needed to be retransmitted, packets in a buffer, and packets received from a gateway, to the target base station 3.

The target base station 3 transmits information corresponding to the current sequence to the terminal based on the data sequence information and data forwarded from the serving base station 2.

Meanwhile, if the handover preparation process (S100) is performed to several neighboring base stations, when it is determined that the terminal 1 has properly performed handover to the target base station 3, the serving base station 2 may request the handover-prepared neighboring base stations except for the target base station 3 among the neighboring base stations to which the handover preparation process is performed to release radio resources prepared for the terminal 1, by transmitting a resource release message. Here, a handover-prepared neighboring base station is a neighboring base station having received the handover request message from the serving base station and having transmitted a handover request response message to the serving base station (S170).

According to the above handover execution, even though the case in which a transmission error occurs because the wireless link between the terminal and the serving base station is not in a good state and then it causes the serving base station to not properly receive the handover indication message from terminal occurs, the terminal can perform handover to the target base station, then the target base station notifies that the terminal has performed handover to the serving base station and requests the serving base station to forward the data sequence number information and data of the terminal, and thereby the seamless handover can be performed.

Also, the interruption time in which the terminal cannot receive data during the handover exists. The interruption time starts from the time at which the serving base station receives a handover indication message when the terminal cuts off the wireless connection with the serving base station, and ends at the time at which the terminal receives downlink data from the target base station for the first time. As such, the interruption time is significantly shorter than the conventional handover interruption time, which starts from the time at which the serving base station transmits an RRC connection reconfiguration message to the terminal.

The handover apparatus according to an exemplary embodiment of the present invention will now be described.

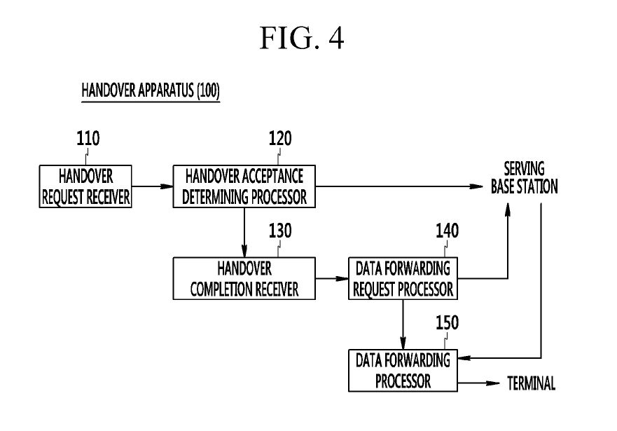

FIG. 4 is a view showing the structure of a handover apparatus according to an exemplary embodiment of the present invention.

The handover apparatus 100 according to an exemplary embodiment of the present invention includes, as shown in FIG. 4, a handover request receiver 110, a handover acceptance determining processor 120, a handover completion receiver 130, a data forwarding request processor 140, and a data forwarding processor 150.

The handover apparatus may be included in a target base station to perform handover based on the cooperation between base stations according to an exemplary embodiment of the present invention.

The handover request receiver 110 receives a handover request message from a serving base station.

The handover request message may include, for example, information on the context of the terminal.

The handover acceptance determining processor 120 determines whether to accept the handover of the terminal based on the handover request from the serving base station.

The handover acceptance determining processor 120 determines whether to accept the handover of the terminal based on the context information of the terminal, and transmits a handover request response message including information needed to access a target base station to the serving base station when allowing the handover of the terminal.

The handover completion receiver 130 receives a message indicating the completion of the handover from the terminal.

Particularly, the handover completion receiver 130 receives a handover completion message from the terminal allowed to perform handover by the handover acceptance determining processor 120 according to the request of the serving base station.

The data forwarding request processor 140 requests the serving base station to forward information on the terminal whether to receive the data sequence number information and data of the terminal from the serving base station or not.

When the data sequence number information and data of the terminal is not received, the data forwarding request processor 140 determines that the abnormal case in which the terminal has performed handover without notifying of performing handover occurs and then transmits an information transfer request message (e.g., an SN Status transfer request message) requesting the data sequence number information and data of the terminal to the serving base station.

The data forwarding processor 150 receives the data sequence number information and data of the terminal from the serving base station and then transmits the data corresponding to the current sequence to the terminal.

According to the exemplary embodiments of the present invention, a target base station notifies of the handover of the terminal to a serving base station and directly requests the serving base station to forward the data sequence number information and data of the terminal, and thereby seamless handover is performed.

Also, as the terminal determines the timing of handover, the handover in which the signal strength measurement results of the base station are reflected in real time is performed.

As a result, the success rate of handover is improved, and data interruption time during handover is significantly shortened. Additionally, the timing of handover can be synchronized between a terminal and base stations in most cases.

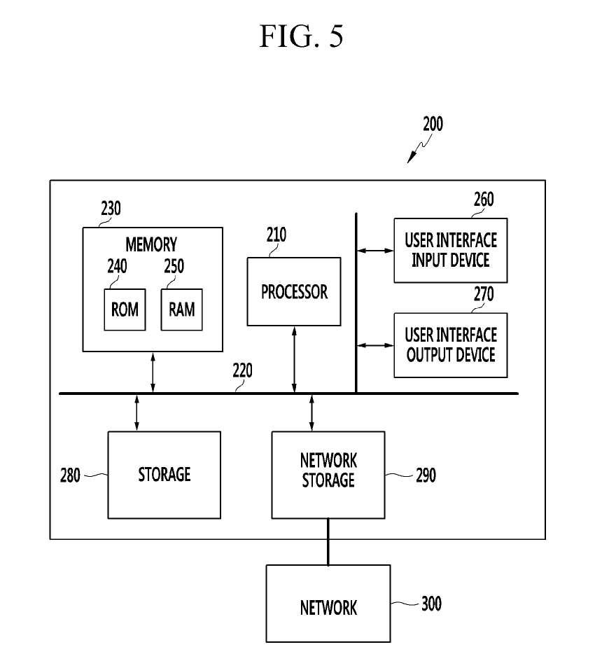

An embodiment of the present invention may be implemented in a computer system, e.g., as a computer readable medium. As shown in in FIG. 5, a computer system 200 may include one or more of a processor 210, a memory 230, a user input device 260, a user output device 270, and a storage 280, each of which communicates through a bus 220. The computer system 200 may also include a network interface 290 that is coupled to a network 300. The processor 210 may be a central processing unit (CPU) or a semiconductor device that executes processing instructions stored in the memory 230 and/or the storage 280. The memory 230 and the storage 280 may include various forms of volatile or non-volatile storage media. For example, the memory may include a read-only memory (ROM) 240 and a random access memory (RAM) 250.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The exemplary embodiments of the present invention may be implemented through the above-described apparatus and/or method, and may also be implemented with a program for realizing the functions corresponding to the elements of the exemplary embodiments of the present invention, and a recording medium storing the program. These implementations may be easily achieved from the description of the exemplary embodiments by a person of ordinary skill in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for handover, comprising:
receiving, by a target base station, a message indicating handover completion from a terminal, wherein the terminal determines whether to perform handover and performs handover to the target base station;
transmitting, by the target base station, a message requesting information on the terminal to a serving base station of the terminal after receiving the message indicating handover completion;
receiving, by the target base station, the information on the terminal from the serving base station; and
transmitting, by the target base station, data to the terminal.

2. The method of claim 1, wherein the transmitting of a message requesting information determines that an abnormal case in which the terminal has performed handover without notifying of performing handover occurs when there is no information on the terminal in the target base station, and transmits the message requesting information to the serving base station.

3. The method of claim 2, wherein the abnormal case represents that the serving base station cannot receive a handover indication message even though the terminal having determined handover timing according to a handover command from the serving base station transmits the handover indication message notifying of handover execution.

4. The method of claim 1, wherein the transmitting of message requesting information transmits a message requesting data sequence number information and data of the terminal to the serving base station.

5. The method of claim 4, further comprising,
after the transmitting of a message requesting information,
transferring, by the serving base station, a sequence number of a PDCP (packet data convergence protocol) SDU (service data unit) needed to be retransmitted, packets in a buffer, and packets received from a gateway.

6. The method of claim 1, further comprising:
before the receiving of a message indicating handover completion,
receiving, by the target base station, a handover request message including information on context of the terminal from the serving base station; and
determining, by the target base station, whether to accept a handover request based on the information and transmitting a handover request response message to the serving base station when accepting the handover request.

7. The method of claim 6, further comprising
transferring information on the terminal to the target base station according to a message requesting the transferring of the information, and then requesting neighboring base stations prepared for handover except for the target base station to release radio resources for the terminal.

8. The method of claim 1, wherein the message indicating handover completion is received after the terminal determines whether to perform handover based on a handover execution event and then performs handover to the target base station, and
the handover execution event includes at least one among
a case in which signal strength of the neighboring base station is greater than signal strength of the serving base station by a first offset value or more,
a case in which the signal strength of the neighboring base station is maintained greater than the signal strength of the serving base station by a second offset value or more during a given TTE (time to execute),
a case in which the signal strength of the neighboring base station is greater than the signal strength of the serving base station and the signal strength of the serving base station is less than a predetermined first threshold, and
a case in which the signal strength of the neighboring base station is greater than the signal strength of the serving base station and the signal strength of the neighboring base station is greater than a predetermined second threshold.

9. An apparatus for handover in a target base station, the apparatus comprising:
a handover completion receiver for receiving a message indicating handover completion from a terminal having determined whether to perform handover or not and having performed handover to a target base station;
a data forwarding request processor for transmitting a message requesting information on the terminal to a serving base station when the message indicating handover completion is received; and
a data forwarding processor for receiving the information on the terminal from the serving base station and transmitting data to the terminal.

10. The apparatus of claim 9, wherein the data forwarding request processor determines that an abnormal case in which the terminal having performed handover without notifying of performing handover occurs when there is no information on the terminal in the target base station, and transmits the message requesting information to the serving base station.

11. The apparatus of claim 10, wherein the message requesting information is a message requesting data sequence number information and data of the terminal.

12. The apparatus of claim 9, further comprising:
a handover request receiver for receiving a handover request message that includes information including context of the terminal from the serving base station; and
a handover acceptance determining processor for determining whether to accept the handover request based on the information and that transmits a handover request response message to the serving base station when accepting the handover request.

13. The apparatus of claim 9, wherein the message indicating handover completion is received after the terminal determines whether to perform handover based on a handover execution event and then performs handover to the target base station.
